(19) United States
(12) Patent Application Publication
(10) Pub. No.: US 2003/0091866 A1
(43) Pub. Date: May 15, 2003

(54) Magnetic recording medium

(75) Inventors: Kiyomi Ejiri, Odawara-shi (JP); Hitoshi Noguchi, Odawara-shi (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/158,170

(22) Filed: May 31, 2002

(30) Foreign Application Priority Data
Jun. 1, 2001 (JP) 166295/2001
Jun. 1, 2001 (JP) 166297/2001

(51) Int. Cl. G11B 5/72

(52) U.S. Cl. 428/694 BP

(57) ABSTRACT

The magnetic recording medium comprising a magnetic layer comprising a ferromagnetic powder and a binder on a nonmagnetic support, wherein a photosensitive layer comprising an organic dye and a nonmagnetic pigment is provided between said nonmagnetic support and said magnetic layer, said magnetic layer has an optical transmittance α equal to or higher than 30 percent at an absorption peak wavelength of said organic dye, and a product Br·δ of a residual magnetic flux density Br and a magnetic layer thickness δ ranges from 0.005 to 0.05 T·μm. The magnetic recording medium comprising a nonmagnetic layer comprising a nonmagnetic powder and a binder and a magnetic layer comprising a ferromagnetic powder and a binder in this order, wherein a photosensitive layer comprising an organic dye and a nonmagnetic pigment is provided between said nonmagnetic layer and a magnetic layer, and said magnetic layer has an optical transmittance equal to or higher than 30 percent at an absorption peak wavelength of said organic dye. By jointly providing an optical recording layer and a magnetic recording layer on the same surface of a support, recording capacity is improved and outputs of magnetic recording signals and optical recording signals and high S/N are obtained.

### FIELD OF THE INVENTION

The present invention relates to a magnetic recording medium combining a magnetic recording layer and an optical recording layer. More specifically, the present invention relates to a magnetic recording medium suitable for reproducing by magnetoresistive (MR) head, in which high volume of information recording and high C/N can be achieved by combining a photosensitive layer and a magnetic layer, or a nonmagnetic layer, photosensitive layer and a magnetic layer on a support.

### BACKGROUND OF THE INVENTION

Means of increasing linear recording density and track density have been proposed to achieve high-density magnetic recording media in recent years. In particular, Belit servo systems of reliably determining track positions, in which signals of differing frequency are prerecorded in deep layer portions of the magnetic layer and magnetic heads track the signals, and, such as described in Japanese Unexamined Patent Publication (KOKAI) Heisei No. 5-36056, optical servo systems of reliably determining track positions, in which physical irregularities are imparted to the magnetic layer surface and an optical means is employed to detect indentations and grooves, have been proposed. However, these methods do not permit the simultaneous recording of a data signal and a servo signal in the same location, and recording capacity is required for recording each type of signal. Thus, when track density is increased using these methods, the recording capacity is finally reduced. Accordingly, to solve this problem, magnetic recording media having both a magnetic recording layer and an optical recording layer and methods of magnetic recording and reproduction have been developed.

For example, Japanese Unexamined Patent Publication (KOKAI) Nos. 2000-76730 and 2000-76731 disclose magnetic recording media for the recording of servo information by providing a surface having a magnetic layer on a nonmagnetic support and a photosensitive layer comprising a dye on the opposite side therefrom. However, in these magnetic recording media, since the servo track is provided on the opposite side from the data track, there is a problem in the form of considerable distance between the magnetically recorded data track and the optically recorded servo track, resulting in poor tracking properties.

Media or methods in which a dye layer is provided beneath the magnetic layer and a servo optical system is recorded and reproduced have been proposed (Japanese Unexamined Patent Publication (KOKAI) Heisei Nos. 7-220322 and 6-187630). In these magnetic recording media, achieving an SIN ratio adequate for optical recording requires increasing the optical transparency of the magnetic layer. To that end, it is necessary to employ a large quantity of a magnetic material of low saturation magnetization σs, decrease the fill rate of the magnetic material, or employ a magnetic layer that is thinner than the conventionally used one. However, satisfying these requirements is problematic in that in all cases, it becomes impossible to ensure adequate magnetic signal reproduction output.

Thus, the present invention, devised to solve the above-stated problems, has an object to provide a magnetic recording medium in which an optical recording layer and a magnetic recording layer, or a nonmagnetic recording layer, an optical recording layer, and a magnetic recording layer, are jointly provided in this order on at least one surface of a support, permitting a high recording capacity and making it possible to achieve high reproduction output and a high SIN for both magnetic recording signals and optical recording signals.

### SUMMARY OF THE INVENTION

The present inventors conducted extensive research into developing a magnetic layer permitting an improvement of recording capacity and exhibiting an adequate reproduction output and high C/N for both of a magnetic recording signal and an optical recording signal, achieving the present invention.

That is, in the first mode of the present invention, the object of the present invention is achieved by a magnetic recording medium comprising a magnetic layer comprising a ferromagnetic powder and a binder on a nonmagnetic support, wherein

a photosensitive layer comprising an organic dye and a nonmagnetic pigment is provided between said nonmagnetic support and said magnetic layer,

said magnetic layer has an optical transmittance α equal to or higher than 30 percent at an absorption peak wavelength of said organic dye, and

a product Br·δ of a residual magnetic flux density Br and a magnetic layer thickness δ ranges from 0.005 to 0.05 T·μm.

In the second mode of the present invention, the object of the present invention is achieved by a magnetic recording medium comprising a nonmagnetic layer comprising a nonmagnetic powder and a binder and a magnetic layer comprising a ferromagnetic powder and a binder in this order, wherein

a photosensitive layer comprising an organic dye and a nonmagnetic pigment is provided between said nonmagnetic layer and a magnetic layer, and

said magnetic layer has an optical transmittance equal to or higher than 30 percent at an absorption peak wavelength of said organic dye.

In the magnetic recording medium of the first mode of the present invention, a photosensitive layer for optical recording and a magnetic layer for magnetic recording are provided on one surface of a nonmagnetic support. In the magnetic recording medium of the second mode of the present invention, a nonmagnetic layer, a photosensitive layer for optical recording, and a magnetic layer for magnetic recording are provided in this order on a nonmagnetic support. Thus, since said magnetic layer can exclusively record information signals, the magnetic recording media of the first and second modes of the present invention permit increased information-recording capacity. Since said photosensitive layer can exclusively record and reproduce servo optical signals, the magnetic recording media of the first and second modes of the present invention permit adequate servo precision and tracking properties for narrow tracks. Further, since the magnetic recording media of the first and second modes of the present invention have an optical transmittance α equal to or higher than 30 percent at an absorption peak wavelength of the organic dye in the magnetic layer, changes in optical properties such as reflectance and transmittance in the photosensitive layer can be readily detected and optical recording reproduction output can be improved.

Further, since the product Br·δ of the residual magnetic flux density Br multiplied by the magnetic layer thickness δ in the magnetic recording medium of the first mode of the present invention ranges from 0.005 to 0.05 T·μm, it is possible to achieve a magnetic recording signal with a high S/N ratio during reproduction with an MR head.

Further, since there is a nonmagnetic layer present between the nonmagnetic support and the photosensitive layer in the magnetic recording medium of the second mode of the present invention, permitting high smoothness of the magnetic layer surface, a magnetic recording signal of higher S/N can be achieved during reproduction with an MR head.

Preferred embodiments of the first mode of the present invention are given below:

(1) A magnetic recording medium in which the ferromagnetic power of the magnetic layer is a hexagonal ferrite ferromagnetic powder with an average particle size of 10 to 50 nm, and in which the thickness of the magnetic layer ranges from 0.03 to 0.3 μm.

(2) A magnetic recording medium in which the thickness of the photosensitive layer ranges from 0.2 to 2.5 μm.

(3) A magnetic recording medium in which the nonmagnetic pigment incorporated into the photosensitive layer is a white pigment.

(4) A magnetic recording medium in which the average particle size of the nonmagnetic pigment incorporated into the photosensitive layer is equal to or higher than 3 nm and equal to or less than ½ of the absorption peak wavelength of the organic dye incorporated into the photosensitive layer.

(5) A magnetic recording medium in which magnetic recording information recorded on the magnetic layer is reproduced with a magnetoresistive head (MR head).

Preferred embodiments of the second mode of the present invention are given below:

(1) A magnetic recording medium in which the product Br·δ of the residual magnetic flux density Br of the magnetic layer multiplied by the magnetic layer thickness δ ranges from 0.005 to 0.05 T·μm.

(2) A magnetic recording medium in which the ferromagnetic powder in the magnetic layer is hexagonal ferrite ferromagnetic power with an average particle size of 10 to 50 nm and in which the thickness of the magnetic layer ranges from 0.03 to 0.3 μm.

(3) A magnetic recording medium in which the thickness of the photosensitive layer ranges from 0.1 to 0.8 μm.

(4) A magnetic recording medium in which the average particle size of the nonmagnetic pigment in the photosensitive layer is equal to or higher than 3 nm and equal to or less than ½ of the absorption peak wavelength of the organic dye incorporated into the photosensitive layer.

(5) A magnetic recording medium in which magnetic recording information recorded on the magnetic layer is reproduced with a magnetoresistive head (MR head).

With respect to the magnetic recording media of the first and second modes of the present invention, the magnetic layer, photosensitive layer, and nonmagnetic support, the nonmagnetic layer of the second mode, and the characteristics of the magnetic recording media of the first and second modes are separately described in detail. Unless expressly stated otherwise, the term “present invention” refers below to both the first and second modes of the present invention.

[Magnetic Layer]

The magnetic layer in the present invention is configured such that the optical transmittance α (also referred to hereinafter as simply the “optical transmittance α”) at the absorption peak wavelength of the organic dye incorporated into the photosensitive layer is equal to or higher than 30 percent, preferably equal to or higher than 40 percent, and more preferably equal to or higher than 50 percent.

Since the optical transmittance a is equal to or higher than 30 percent, it is possible for a servo optical signal to be recorded in the photosensitive layer without substantial influence by the magnetic layer during the recording of a servo optical signal for tracking servo. Thus, since recording capacity is not required for the servo optical signal in the magnetic layer, the entire surface area of the magnetic layer can be employed to record and reproduce information, greatly increasing recording capacity. Further, since changes in optical properties based on heat emission and photons, such as reflectance, transmittance, and refractive index, are readily detected in the photosensitive layer, described further below, when reproducing the servo optical signal, the magnetic (MR) head can precisely track the servo optical signal recorded on the photosensitive layer.

An optical transmittance equal to or higher than 30 percent can be achieved by adjusting the thickness of the magnetic layer. That is, to achieve an optical transmittance α in the magnetic layer equal to or higher than 30 percent, it is desirable to employ a magnetic layer equal to or less than 0.15 μm in thickness when employing an Fe metal as the ferromagnetic power, and to employ a magnetic layer equal to or less than 0.3 μm in thickness when employing an iron oxide or hexagonal ferrite as the ferromagnetic powder. Additives that greatly absorb transmitted light, such as strongly colored abrasives and carbon black, are preferably added as small amount as possible.

In the magnetic layer in the present invention, the product Br·δ of the residual magnetic flux density Br multiplied by the magnetic layer thickness δ desirably ranges from 0.005 to 0.05 T·μm, preferably from 0.005 to 0.03 T·μm, and more preferably from 0.007 to 0.025 T·μm. When Br·δ is equal to or higher than 0.005 T·μm, the level of magnetization is adequate and good output can be achieved. When Br·δ is equal to or less than 0.05 T·δm, the MR head does not saturate and noise does not increase.

To achieve a Br·δ within a range of 0.005 to 0.05 μm, the residual magnetic flux density Br and the thickness δ are adjusted. Since magnetic layer thickness δ ranges from 0.03 to 0.3 μm as set forth further below, the residual magnetic flux density Br is principally adjusted to achieve the desired Br·δ. Br adjustment can be achieved by setting the saturation magnetization σs and fill density of the magnetic material.

To achieve a magnetic recording signal with a good S/N in the magnetic layer of the present invention, the magnetic recording medium of the present invention is desirably reproduced with a high-sensitive MR head. That is, to achieve a good S/N in the magnetic layer, it is necessary to reduce granular noise. To this end, the magnetization level of the magnetic layer must not be reduced within the range in which it is possible to ensure reproduction output. Thus, use of a high-sensitive MR head is particularly desirable because a good S/N can be achieved due to adequate compensation for the inadequate magnetic signal accompanying reduction in the magnetization level.

<Ferromagnetic Powder>

Examples of ferromagnetic powders suitable for use in the magnetic layer of the present invention are ferromagnetic metal powders and hexagonal ferrite magnetic powders. Of these, the use of hexagonal ferrite magnetic powders with good optical transmittance is preferred.

(Ferromagnetic Metal Powders)

Preferred ferromagnetic metal powders are those having a principal component in the form of α-Fe. In addition to prescribed atoms, the ferromagnetic metal powder may comprised the following atoms: Al, Si, Ca, Mg, Ti, Cr, Cu, Y, Sn, Sb, Ba, W, La, Ce, Pr, Nd, P, Co, Mn, Zn, Ni, Sr, and B. The incorporation of at least one from among Al, Ca, Mg, Y, Ba, La, Nd, Sm, Co, and Ni in addition to α-Fe is desirable. The formation of an alloy of Co and Fe is particularly desirable because saturation magnetization increases and there is improvement in demagnetization. The content of Co relative to Fe desirably ranges from 1 to 40 atomic percent, preferably from 15 to 35 atomic percent, and more preferably from 20 to 35 atomic percent. The content of rare earth elements such as Y desirably ranges from 1.5 to 12 atomic percent, preferably from 3 to 10 atomic percent, and more preferably from 4 to 9 atomic percent. The content of Al desirably ranges from 1.5 to 12 atomic percent, preferably from 3 to 10 atomic percent, and more preferably from 4 to 9 atomic percent. These ferromagnetic powders may be pretreated with dispersants, lubricants, surfactants, antistatic agents, and the like prior to dispersion.

A small quantity of hydroxide or oxide may be incorporated into the ferromagnetic metal power. Ferromagnetic metal powder obtained by known manufacturing methods may be employed. Examples of methods are given below: the method of obtaining Fe or Fe—Co particles by reducing with a reducing gas a hydrous iron oxide or iron oxide that has been treated to prevent sintering; the method of reducing a complex organic acid salt (primarily oxalates) by means of a reducing gas such as hydrogen or the like; the method of thermally decomposing a metal carbonyl compound; the method of reduction by adding a reducing agent such as sodium boron hydride, hypophosphite, or hydrazine to an aqueous solution of a ferromagnetic metal; and the method of obtaining micropowders by vaporizing a metal in an inert gas at low pressure. The ferromagnetic metal powders thus obtained are subjected to known slow oxidation treatments. Methods in which hydrous iron oxide or iron oxide is reduced with a reducing gas such as hydrogen and the partial pressures of the oxygen-comprising gas and inert gas, the temperature, and the time are controlled to form an oxide film on the surface result in little demagnetization and are preferred.

The specific surface area by BET method of the ferromagnetic metal powder in the magnetic layer of the present invention normally ranges from 40 to 80 m² μg and preferably from 45 to 70 m²/g. At less than 40 m²/g, noise increases undesirably, and at greater than 80 m²/g, it becomes difficult to achieve a smooth surface, thus both are not preferred. The crystallite size of the ferromagnetic metal powder normally ranges from 80 to 180 Å, preferably from 100 to 170 Å, and more preferably from 110 to 165 Å. The mean major axis length of the ferromagnetic metal powder normally ranges from 0.02 to 0.25 μm, preferably from 0.03 to 0.15 μm, and more preferably from 0.03 to 0.12 μm. The acicular ratio of the ferromagnetic metal powder desirably ranges from 3 to 15 and preferably from 3 to 10. The saturation magnetization (a s) of the magnetic metal powder normally ranges from 90 to 170 A m²/kg (emu/g), preferably from 100 to 160 A·m²/kg (emu/g), and more preferably from 110 to 160 A·m²/kg (emu/g). The coercivity Hc of the ferromagnetic metal powder desirably ranges from 135.3 to 278.6 kA/m (1,700 to 3,500 Oe), preferably from 143.3 to 238.8 kA/m (1,800 to 3,000 Oe).

The moisture content of the ferromagnetic metal powder desirably ranges from 0.1 to 2 mass percent; the moisture content of the ferromagnetic metal powder is desirably optimized by means of the type of binder. The pH of the ferromagnetic metal powder is desirably optimized in combination with the binder employed; the range is normally pH 6 to 12, preferably pH 7 to 11. The stearic acid (SA) adsorption capacity of the ferromagnetic metal powder (the scale of basic points on the surface) is usually 1 to 15 μmol/m², preferably from 2 to 10 μmol/m², and more preferably from 3 to 8 μmol/m². When employing a ferromagnetic metal powder with a high stearic acid adsorption capacity, surface modification with an organic compound adsorbing strongly onto the surface is desirable to create a magnetic recording medium. Soluble inorganic ions such as Na, Ca, Fe, Ni, Sr, NH₄, SO₄, Cl, NO₂, and NO₃ are sometimes contained in the ferromagnetic powder. It is desirable for these to be essentially absent. At a total ion content equal to or less than about 300 ppm, characteristics are unaffected. Further, the ferromagnetic powder employed in the present invention desirably has few pores. The content of pores is equal to or less than 20 volume percent, preferably equal to or less than 5 volume percent. So long as the above-stated particle size and magnetic characteristics are satisfied, the particles may be acicular, rice-particle shaped, or spindle-shaped. The switching field distribution (SFD) of the ferromagnetic powder itself is desirably low, and it is necessary to decrease the Hc distribution of the ferromagnetic powder. When the tape SFD is low, magnetic reversal is sharp and the peak shift is low, which is suitable for high-density digital magnetic recording. A low Hc distribution is achieved, for example, by improving the goethite particle size distribution in the ferromagnetic metal powder; by employing monodispersed α-Fe₂O₃; by preventing sintering between particles.

(Hexagonal Ferrite Magnetic Powder)

The use of hexagonal ferrite as the ferromagnetic powder in the magnetic layer of the present invention is desirable because a relatively low saturation magnetization σs, a good SIN ratio at high linear recording densities, and high optical transmittance are achieved.

Examples of hexagonal ferrite magnetic powders suitable for use in the magnetic layer of the present invention are various substitution products of barium ferrite, strontium ferrite, lead ferrite, and calcium ferrite, and Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite magnetic powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed.

The particle size of the hexagonal ferrite magnetic powder is as a hexagonal plate diameter, 10 to 50 nm, preferably 10 to 40 nm, and more preferably 15 to 35 nm. Particularly when employing MR heads in reproduction, a plate diameter equal to or less than 40 nm is desirable to reduce noise. An average plate diameter equal to or higher than 10 nm yields stable magnetization without the effects of thermal fluctuation. An average plate diameter equal to or less than 50 nm permits low noise and is suited to the high-density magnetic recording of the present invention. The plate ratio (plate diameter/plate thickness) of the hexagonal ferrite magnetic powder desirably ranges from 1 to 15, preferably from 1 to 7. To achieve adequate orientation while maintaining a high filling property, the plate ratio is desirably equal to or higher than 1. When the plate ratio is equal to or less than 15, noise can be prevented due to stacking between particles.

The specific surface area by BET method of the hexagonal ferrite particles ranges from 10 to 100 m²/g, almost corresponding to an arithmetic value from the particle plate diameter and the plate thickness. Narrow distributions of particle plate diameter and thickness are normally good. Although difficult to render in number form, 500 particles can be randomly measured in a TEM photograph of particles to make a comparison. This distribution is often not a normal distribution. However, when expressed as the standard deviation to the average particle size, σ/average particle size=0.1 to 2.0. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known. The average particle volume of the hexagonal ferrite powder ranges from 1,000 to 10,000 nm³, preferably 1,500 to 8,000 nm³, and more preferably from 2,000 to 8,000 nm³.

A coercivity (Hc) of the hexagonal ferrite magnetic powder as measured in the magnetic layer of about 40 to 400 kA/m can normally be achieved. A high coercivity Hc is advantageous for high-density recording, but this is limited by the capacity of the recording head. The coercivity (Hc) of the hexagonal ferrite magnetic powder in the present invention is desirably about 110 to 395 kA/m, preferably 126 to 320 kA/m. When the saturation magnetization (σs) of the recording head exceeds 1.4 T, a coercivity equal to or higher than 175 kA/m is desirable. Coercivity (Hc) can be controlled by particle size (plate diameter and plate thickness), the types and quantities of elements contained, substitution sites of the element, the particle producing reaction conditions, and the like. The saturation magnetization (σs) of the hexagonal ferrite magnetic powder is 40 to 80 Am²/kg. The saturation magnetization (σs) tends to decrease with decreasing particle size. Known methods of improving saturation magnetization (σs) are combining spinel ferrite with magnetoplumbite ferrite, selection of the type and quantity of elements incorporated, and the like. It is also possible to employ W-type hexagonal ferrite magnetic powder.

When dispersing hexagonal ferrite magnetic powder, the surface of the magnetic material particles is processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added ranges from 0.1 to 10 mass percent relative to the hexagonal ferrite magnetic powder. The pH of the hexagonal ferrite magnetic powder is also important to dispersion. A pH of 4 to 12 is usually optimum for the dispersion medium and polymer From the perspective of the chemical stability and storage properties of the medium, a pH of about 6 to 11 can be selected. Moisture contained in the hexagonal ferrite magnetic powder also affects dispersion. There is an optimum level for the dispersion medium and polymer, usually selected from the range of 0.01 to 2.0 percent.

Methods of manufacturing hexagonal ferrite include the glass crystallization method in which a metal oxide substituted with barium oxide, iron oxide, and iron, and a glass-forming substance in the form of boron oxide or the like are mixed in proportions designed to yield a desired ferrite composition, melted, and quenched to obtain an amorphous product, subjected to a heat treatment again, washed, and pulverized to obtain barium ferrite crystal powder; the hydrothermal reaction method in which a barium ferrite composition metal salt solution is neutralized with an alkali, the by-products are removed, the solution is liquid-phase heated at equal to or higher than 100° C., and the solution is washed, dried, and pulverized to obtain barium ferrite crystal powder; and the coprecipitation method in which a barium ferrite composition metal salt solution is neutralized with an alkali, the by-products are removed, and the solution is dried, processed at equal to or less than 1,100° C., and pulverized to obtain barium ferrite crystal powder. However, any methods may be employed in the present invention.

<Binder>

Conventionally known thermoplastic resins, thermosetting resins, reactive resins and mixtures thereof may be employed as binders employed in the magnetic layer of the present invention. The thermoplastic resins have a glass transition temperature of −100 to 150° C., have a number average molecular weight of 1,000 to 200,000, preferably 10,000 to 100,000, and have a degree of polymerization of about 50 to 1,000. In the present invention, a binder employed in the magnetic upper layer and a binder employed in a photosensitive layer mentioned below may be the same or different. Examples are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins.

Further, examples of thermosetting resins and reactive resins of the binder are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in the Handbook of Plastics published by Asakura Shoten. It is also possible to employ known electron beam-cured resins in individual layers. Examples thereof and methods of manufacturing the same are described in detail in Japanese Unexamined Patent Publication (KOKAI) Showa No. 62-256219. The above-listed resins may be used singly or in combination. Preferred resins are combinations of polyurethane resin and at least one member selected from the group consisting of vinyl chloride resin, vinyl chloride—vinyl acetate copolymers, vinyl chloride—vinyl acetate—vinyl alcohol copolymers, and vinyl chloride—vinyl acetate—maleic anhydride copolymers, as well as combinations of the same with polyisocyanate.

Known polyurethane resins may be employed, such as polyester polyurethane, polyether polyurethane, polyether polyester polyurethane, polycarbonate polyurethane, polyester polyearbonate polyurethane, and polycaprolactone polyurethane. A binder obtained by incorporating as needed one or more polar groups selected from among —COOM, —SO₃M, —OSO₃M, —P═O(OM)₂, and —O—P═O(OM)₂ (where M denotes a hydrogen atom or an alkali metal base), —OH, —NR₂, —N+R₃ (where R denotes a hydrocarbon group), epoxy group, —SH, and —CN into any of the above-listed binders by polymerization or addition reaction to improve dispersion properties and durability is desirably employed. The quantity of such a polar group ranges from 10⁻¹ to 10⁻⁸ mol/g, preferably from 10⁻² to 10⁻⁶ mol/g.

The binder employed in the magnetic layer of the present invention can be added in a range yielding an optical transmittance α equal to or higher than 30 percent in the magnetic layer. The quantity of binder added can fall within a range of 5 to 50 mass percent relative to the ferromagnetic powder, preferably a range of 10 to 30 mass percent. When using vinyl chloride resin, a range of 5 to 30 mass percent; when using polyurethane resin, a range of 2 to 20 mass percent; and when using polyisocyanate, a range of 2 to 20 mass percent is desirably employed in combination. However, when head corrosion occurs due to the release of small amounts of chlorine, for example, it is possible to employ just polyurethane or polyurethane and isocyanate. When employing polyurethane, the glass transition temperature ranges from −50° C. to 150° C., preferably from 0 to 100° C., and more preferably 30 to 90° C. It is preferable that the elongation at break ranges from 100 to 2,000 percent, the stress at break ranges from 0.49 to 98 MPa (0.05 to 10 kg/mm²), and the yield point ranges from 0.49 to 98 MPa (0.05 to 10 kg/mm²).

<Carbon Black>

As needed, carbon black can be employed in the magnetic layer of the present invention. However, the quantity and type of carbon black employed differs from those of conventional magnetic recording media by being limited to a range yielding an optical transmittance equal to or higher than 30 percent.

Examples of such a carbon black are furnace black for rubber, thermal for rubber, black for coloring, and acetylene black. In the carbon black, a specific surface area of 5 to 500 m²/g, a DBP oil absorption capacity of 10 to 400 mL/100 g, a particle diameter of 5 to 300 nm (mμ), preferably 10 to 250 nm (mμ), further preferably 20 to 200 nm (mμ). In the carbon black, a pH of 2 to 10, a moisture content of 0.1 to 10 percent, and a tap density of 0.1 to 1 g/mL are desirable. The carbon black employed may be surface-treated with a dispersant or the like, or grafted with resin, or have a partially graphite-treated surface. The carbon black may be dispersed in advance into the binder prior to addition to the magnetic coating material. These carbon blacks may be used singly or in combination. When employing carbon black, the quantity added preferably ranges from 0.1 to 5 percent relative to the magnetic material. In the magnetic layer, carbon black works to prevent static buildup, reduce the coefficient of friction, enhance film strength and the like; the properties vary with the type of carbon black.

<Abrasives>

Abrasives may be incorporated into the magnetic layer (including the photosensitive layer described further below) of the present invention in a range capable of yielding an optical transmittance equal to or higher than 30 percent. Chiefly, known materials with a Mohs' hardness equal to or higher than 6 may be employed singly or in combination; examples are α-alumina having an a -conversion rate equal to or higher than 90 percent, β-alumina, silicon carbide, chromium oxide, cerium oxide, α-iron oxide, corundum, artificial diamond, silicon nitride, silicon carbide, titanium carbide, titanium oxide, silicon dioxide, and boron nitride. Further, a composite comprising two or more of these abrasives (an abrasive obtained by surface-treating one abrasive with another) may also be used. Although these abrasives may contain compounds and elements other than the main component in some cases, the same effect is obtainable if the content of the main component is equal to or higher than 90 percent. However, abrasives with intense colors such as green and black absorb a large amount of transmitted light, and are thus desirably avoided to the extent possible. The particle size of these abrasives desirably ranges from 0.01 to 2 μm, preferably from 0.05 to 1.0 μm, and more preferably from 0.05 to 0.5 μm. In particular, to improve electromagnetic characteristics, a narrow particle size distribution is desirable. To improve durability, a binder of differing particle size may be combined as needed. The same effect may also be achieved using a single binder with widening the particle size distribution. A tap density of 0.3 to 2 g/mL, a moisture content of 0.1 to 5 percent, a pH of 2 to 11, and a specific surface area of 1 to 30 m²/g are desirable. The abrasive employed in the present invention may be acicular, spherical, or cubic in shape, but shapes that are partially angular have good abrasion properties and are thus preferred.

<Other Additives>

Lubricants, antistatic agents, dispersants, dispersion adjuvants, plasticizers, mildewcides, anti-oxidation agents, solvents, and the like may be further incorporated into the magnetic layer of the present invention (including the photosensitive layer described further below) within a range permitting an optical transmittance equal to or higher than 30 percent. Examples are: silicone oils; silicones having a polar group; fatty acid-modified silicones; fluorine-containing silicones; fluorine-containing alcohols; fluorine-containing esters; polyolefins; polyglycols; alkylphosphoric esters and their alkali metal salts; alkylsulfuric esters and their alkali metal salts; polyphenyl ethers; phenyl phosphonates; α-naphthyl phosphates; phenyl phosphates; diphenyl phosphates; p-ethylbenzenephosphonic acids; phenylphosphinic acids, aminoquinones; various silane coupling agents; titanium coupling agents; fluorine-containing alkylsulfuric esters and their alkali metal salts; monobasic fatty acids having 10 to 24 carbon atoms (which may contain an unsaturated bond or may be branched) and metal (e.g., Li, Na, K, Cu) salts thereof, monohydric, dihydric, trihydric, tetrahydric, pentahydric and hexahydric alcohols having 12 to 22 carbon atoms (which may contain an unsaturated bond or be branched); alkoxy alcohols having 12 to 22 carbon atoms; monofatty esters, difatty esters, or trifatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 12 carbon atoms (which may contain an unsaturated bond or be branched); fatty esters of monoalkyl ethers of alkylene oxide polymers; fatty acid amides having 8 to 22 carbon atoms; and aliphatic amines having 8 to 22 carbon atoms. Specific examples of additives suitable for use are: fatty acids such as capric acid, caprylic acid, lauric acid, myristic acid, palmitic acid, stearic acid, behenic acid, oleic acid, elaidic acid, linolic acid, linolenic acid, and isostearic acid. Examples of esters are butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, tridecyl stearate, oleyl erucate, neopentylglycol didecanoate, and ethylene glycol dioleyl. Examples of alcohols are oleyl alcohol, stearyl alcohol, and lauryl alcohol. It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and amphoteric surfactants such as amino acids, amino sulfonic acids, sulfuric or phosphoric esters of amino alcohols, and alkyl betaines. Details of these surfactants are described in “Surfactants Handbook” (published by Sangyo Tosho Co., Ltd.). These lubricants, antistatic agents and the like need not be 100 percent pure and may contain impurities, such as isomers, unreacted materials, by-products, decomposition products and oxides in addition to the main components. These impurities are preferably comprised equal to or less than 30 percent, and more preferably equal to or less than 10 percent.

The lubricants and surfactants that are employed in the present invention individually have different physical properties, and type and quantity thereof and a combination ratio of lubricants for providing synergistic effects should be optimally determined according to the purpose. For example, it is conceivable to control bleeding onto the surface through the use in the magnetic layer of fatty acids having different melting points, to control bleeding onto the surface through the use of esters having different boiling and melting points and polarities, to improve coating stability by adjusting the amount of surfactant, and to enhance the lubricating effect by increasing the amount of the lubricant added to the middle layer; this is not limited to the examples given here. The total amount of the lubricant is normally selected within the range of 0.1 to 50 mass percent, preferably 2 to 25 mass percent with respect to the ferromagnetic powder.

All or some of the additives used in the present invention may be added at any stage of the process of manufacturing process the magnetic liquid. For example, they may be mixed with the magnetic powder before a kneading step; added during a step of kneading the magnetic powder, the binder, and the solvent; added during a dispersing step; added after dispersing; or added immediately before coating. According to the purpose, part or all of the additives may be applied by simultaneous or sequential coating after the magnetic layer has been applied to achieve a specific purpose. Depending on the objective, the lubricant may be coated on the surface of the magnetic layer after calendering or making slits.

In the present invention, known organic solvents can be used in any ratio. Examples are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol and methylcyclohexanol; esters such as methyl acetate, butyl acetate, isobutyl acetate, isopropyl acetate, ethyl lactate and glycol acetate; glycol ethers such as glycol dimethyl ether, glycol monoethyl ether, and dioxane; aromatic hydrocarbons such as benzene, toluene, xylene, cresol and chlorobenzene; chlorinated hydrocarbons such as methylene chloride, ethylene chloride, carbon tetrachloride, chloroform, ethylene chlorohydrin and dichlorobenzene; N,N-dimethylformamide; and hexane.

These organic solvents need not be 100 percent pure and may contain impurities such as isomers, unreacted materials, by-products, decomposition products, oxides and moisture in addition to the main components. The content of these impurities is preferably equal to or less than 30 percent, more preferably equal to or less than 10 percent. The amount added of the organic solvent employed in the present invention may be varied. To improve dispersion properties, a solvent having a somewhat strong polarity is desirable. It is desirable that solvents having a dielectric constant equal to or higher than 15 is comprised equal to or higher than 50 percent of the solvent composition. Further, the dissolution parameter is desirably from 8 to 11.

<Characteristics of the Magnetic Layer>

The thickness of the magnetic layer of the present invention ranges from 0.03 to 0.3 μm, preferably from 0.05 to 0.2 μm. A magnetic layer with a thickness equal to or higher than 0.03 μm ensures a level of magnetization delivering adequate reproduction output. At equal to or less than 0.3 μm, there is no deterioration of the overwriting deletion rate.

The coercivity (Hc) in the magnetic layer is to be equal to or higher than 127.4 kA/m (1,600 Oe), preferably 143.3 to 398 kA/m (1,800 to 5,000 Oe). In the magnetic distribution of the magnetic layer, it is desirable to further specify that an applied magnetic field equal to or less than 79.6 kA/m (1,000 Oe) results in a maximum magnetic reversal component of less than 1 percent, preferably equal to or less than 0.7 percent, and still more preferably equal to or less than 0.5 percent. The squareness SQ of the magnetic layer ranges from 0.55 to 0.95, preferably from 0.6 to 0.9 in the longitudinal direction when the tape medium is recorded in the so-called longitudinal recording. When SQ is equal to or higher than 0.55, the level of magnetization is adequate and sufficient output is achieved. When SQ is equal to or less than 0.95, there is little aggregation of magnetic particles due to the orientation field, preventing noise. In longitudinal recording on disk-shaped media, circumferential or random orientation is desirable. In that case, the SQ desirably ranges from 0.4 to 0.6 at any point along the circumference. It is also possible to orientate the magnetic particles vertically. In that case, a SQ of 0.55 to 0.9 is desirable in the vertical direction.

A glass transition temperature (the temperature at which the loss elastic modulus of dynamic viscoelasticity as measured at 110 Hz peaks) of 50 to 120° C. is desirable in the magnetic layer. The loss elastic modulus preferably falls within a range of 1×10³ to 8×10⁴ N/cm² (1×10⁸ to 8×10⁹ dyne/cm²) and the loss tangent is preferably equal to or less than 0.2. Adhesion failure tends to occur when the loss tangent becomes excessively large. These thermal and mechanical characteristics of the medium desirably vary by equal to or less than 10 percent in any in-plane direction. The residual solvent contained in the magnetic layer is preferably equal to or less than 100 mg/M², more preferably equal to or less than 10 mg/m². The void ratio in the magnetic layer is preferably equal to or less than 30 volume percent, more preferably equal to or less than 20 volume percent. Although a low void percentage is preferable for attaining high output, there are some cases in which it is better to maintain a certain level. For example, in disk-shaped magnetic recording media where repeat applications are important, higher void ratios often result in better running durability.

The center-surface average surface roughness Ra of the magnetic layer is equal to or less than 4.0 nm, preferably equal to or less than 3.8 nm, and more preferably equal to or less than 3.5 nm, as measured by the Mirau method with a TOPO-3D made by WYCO. It is preferable that the maximum height SR_{MAX} of the magnetic layer is equal to or less than 0.5 μm, the ten-point average roughness SR_{Z} is equal to or less than 0.3 μm, the center surface peak roughness SR_{P} is equal to or less than 0.3 μm, the center surface valley depth SR_{V} is equal to or less than 0.3 μm, the center surface area ratio SSᵣ ranges from 20 to 80 percent, and the average wavelength Sλₐ ranges from 5 to 300 μm.

Surface protrusions on the magnetic layer are desirably adjusted to optimize electromagnetic characteristics and the coefficient of friction. Surface protrusions are readily adjusted by controlling surface properties by means of fillers employed in the nonmagnetic support, controlling the particle size and quantity of powder added to the magnetic layer as set forth above, and controlling the surface topography of the rolls employed in calendering. Curling is desirably held to ±3 mm.

[The Photosensitive Layer]

In the first mode of the present invention, the photosensitive layer is provided between the nonmagnetic support, described further below, and the magnetic layer mentioned above. In the second mode of the present invention, the photosensitive layer is provided between the nonmagnetic layer, described further below, and the magnetic layer mentioned above. The photosensitive layer comprises organic dye and nonmagnetic pigments. The binders, lubricants, and the like described for the magnetic layer may also be suitably employed.

<Organic Dye>

The organic dyes contained in the photosensitive layer of the present invention are not specifically limited other than that they be able to effectively absorb irradiated light and undergo a change in chemical structure, and thus undergoing a change in an optical characteristic such as reflectance, transmittance, refractive index, polarization degree, or the like based on the generation of either heat or photons by the irradiated light; they may be selected as desired. Examples of such dyes are known organic dyes such as: cyanine based dyes such as cyanine dyes and merocyanine dyes, phthalocyanine based dyes, naphthalocyanine based dyes, oxonol based dyes, azomethine based dyes, azo based dyes, anthraquinone based dyes, naphthoquinone based dyes, pyrylium based dyes, thiopyrylium based dyes, azulenium based dyes, susquarylium based dyes, triallylmethane based dyes, aluminum based, diimmonium based dyes, and nitroso compounds, as well as metal complexes comprising these dye structures as ligands. These may be employed singly or in mixtures of two or more. Organic dyes may also suitably comprise substituents to improve compatibility with the solvent and resin employed in the photosensitive layer coating liquid, or polar groups to enhance adsorption to nonmagnetic pigments, to the extent that optical characteristics are not lost.

A specific example of a cyanine-based dye is the compound denoted by general formula (a) below.

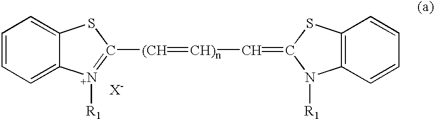

In general formula (a), R₁ denotes an alkyl group with 1 to 10 carbon atoms. X— denotes an anion such as Cl—, ClO₄—, Br—, BF₄—, or CF₃SO₃—. And n denotes an integer of 0 to 4. Specific examples of R₁ are methyl groups, ethyl groups, n-butyl groups, isobutyl groups, and 2-ethylhexyl groups. Of these, employing an n-butyl group as R₁ is desirable in that solubility is high and the coating liquid is easily prepared. When n is one of the values indicated below in general formula (a), the use of the lasers of the wavelengths indicated below is effective.

| | |
|---|---|
| n = 0 | wavelength 423 ± 25 nm |
| n = 1 | wavelength 557 ± 25 nm |
| n = 2 | wavelength 650 ± 25 nm |
| n = 3 | wavelength 758 ± 25 nm |

The above-described dye corresponding to the laser beam to which it is sensitive is suitably selected and incorporated into the photosensitive layer of the present invention. For example, when forming a photosensitive layer sensitive to infrared light, a compound with n=3 in general formula (a) is employed. Further, when forming a photosensitive layer sensitive to red, a compound with n=2 in general formula (a) is employed. Further, when forming a photosensitive layer sensitive to blue, a compound with n=0 in general formula (a) is employed.

The content of the organic dye in the photosensitive layer is suitably determined based on the film thickness of the photosensitive layer and the type of organic dye employed. Since resolution generally decreases when the concentration of the organic dye is excessively high or low, the organic dye is added within a range yielding an adequate resolution, and the transmittance, reflectance, and refractive index are optimally designed. For example, the content of such an organic dye preferably ranges from 0.1 to 100 mass parts, more preferably from 0.5 to 70 mass parts, and most preferably from 1 to 50 mass parts, per 100 mass parts of the nonmagnetic pigment described further below.

<Nonmagnetic Pigment>

Since those of the above-described organic dyes having relatively low molecular weight are capable of dissolving into the solvent in the magnetic layer, they tend to diffuse into the magnetic layer above the photosensitive layer. When the organic dye diffuses into and contaminates the magnetic layer, it may be caused that the magnetic material fill density of the magnetic layer decreases and the optical transmittance in the magnetic layer decreases.

The nonmagnetic pigment incorporated into the photosensitive layer serves the function of adsorbing to and holding the organic dye molecules, thereby preventing them from diffusing from the photosensitive layer into the magnetic layer. The nonmagnetic pigment particles also form suitable voids in the photosensitive layer, increasing the moldability of the photosensitive layer by calendering. As a result, the smoothness and reflectance of the magnetic layer surface coated onto the photosensitive layer are increased.

Examples of nonmagnetic pigments incorporated into the photosensitive layer in the present invention are nonmagnetic inorganic compounds such as metal oxides, metal carbonates, metal sulfates, metal nitrides, metal carbides and metal sulfides, melamine dyes, and benzoguanamine resin particles. The use of a main component in the form of black particles such as carbon black and titanbide as nonmagnetic powders is undesirable because they absorb and block light. Accordingly, the nonmagnetic pigment in the present invention is desirably a white pigment capable of enhancing the difference between the changing component in the form of a fading dye or the like and the other components and increasing detection sensitivity.

Specific examples of nonmagnetic pigments which may be used singly or in combination are α-alumina having an α-conversion rate equal to or higher than 90 percent, β-alumina, γ-alumina, θ-alumina, silicon carbide, chromium oxide, cerium oxide, α-iron oxide, hematite, goethite, corundum, silicon nitride, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, zinc oxide, indium oxide, and ITO (tin oxide - indium oxide). Nonmagnetic pigments of particular preference are chemically stable oxides that are white or colorless in the form of titanium dioxide, zinc oxide, tin oxide, indium oxide, ITO, zirconium oxide, tungsten oxide, and silicon dioxide. The nonmagnetic pigments of greatest preference are those with good electrical conductivity, namely, tin oxide, indium oxide, zinc oxide, and ITO. These oxides may be doped with Sb or the like to enhance electrical conductivity.

The primary particle size of the above-listed nonmagnetic pigments is equal to or higher than 3 nm and equal to or less than ½ of the absorption peak wavelength (for example, 390 nm for a dye with absorption peak at 780 nm) of the organic dye employed, preferably 10 to 200 nm, and more preferably 15 to 150 nm. When the primary particle size of the pigment is equal to or higher than 3 nm, the nonmagnetic pigment can be dispersed readily and the surface roughness of the magnetic layer can be low. Further, when the primary particle size of the pigment is equal to or less than ½ of the absorption peak wavelength of the organic dye, there is little optical scattering and the S/N ratio of the optical signal can be improved.

Further, other substances and nonmagnetic pigments of differing particle size may be combined as needed in the nonmagnetic pigment in the present invention. The primary particles of the nonmagnetic pigment may be spherical, plate-shaped, or acicular in shape. The tap density ranges from 0.05 to 2 g/mL, preferably from 0.2 to 1.5 g/mL. The moisture content of the nonmagnetic pigment ranges from 0.1 to 5 mass percent, preferably from 0.2 to 3 mass percent, and more preferably from 0.3 to 1.5 mass percent. The pH of the nonmagnetic pigment ranges from 2 to 11; however, a pH of 5.5 to 10 is particularly desirable. The specific surface area of the nonmagnetic pigment ranges from 1 to 100 m²/g, preferably from 5 to 80 m²/g, and more preferably from 10 to 70 m²/g. The DBP (dibutyl phthalate) oil absorption capacity ranges from 5 to 100 mL/100 g, preferably from 10 to 80 mL/100 g, and more preferably from 20 to 60 mL/100 g. The specific gravity ranges from 1 to 12, preferably from 3 to 7. The Mohs' hardness desirably ranges from 2 to 10. These nonmagnetic pigments may be surface treated based on the objective to improve the dispersion and light fastness thereof.

The content of nonmagnetic pigment is suitably determined based on the film thickness of the photosensitive layer and the type of nonmagnetic pigment employed. For example, the ratio by mass parts of nonmagnetic pigment to binder desirably ranges from 95:5 to 50:50.

The film thickness of the photosensitive layer can be made thin when detecting changes in transmittance and thick when detecting changes in reflectance, for example.

In the first mode of the present invention, the film thickness of the photosensitive layer desirably ranges from 0.2 to 2.5 μm, preferably from 0.2 to 2.0 μm, and more preferably from 0.3 to 1.5 μm. When the film thickness of the photosensitive layer is equal to or higher than 0.2 μm, an adequate calendering forming effect can be achieved and the magnetic layer surface can be made smooth. When the film thickness of the photosensitive layer is equal to or less than 2.5 μm, the recording light reaches to deep portions of the photosensitive layer and an adequate change in dye can be achieved, making it possible to maintain good optical signal resolution. Further, since it is unnecessary to expose the photosensitive layer to a strong light for an extended period to achieve optical characteristics, diminished recording efficiency and heat damage to the magnetic layer can be prevented.

In the second mode of the present invention, the film thickness of the photosensitive layer desirably ranges from 0.05 to 0.8 am, preferably from 0.1 to 0.6 μm, and more preferably from 0.1 to 0.4 μm. When the film thickness of the photosensitive layer is equal to or higher than 0.1 μm, an adequate S/N can be achieved with the organic dye. When the film thickness of the photosensitive layer is equal to or less than 0.8 μm, the recording light reaches to deep portions of the photosensitive layer and an adequate change in dye can be achieved, making it possible to maintain good optical signal resolution. Further, since it is unnecessary to expose the photosensitive layer to a strong light for an extended period to achieve optical characteristics, diminished recording efficiency and heat damage to the magnetic layer can be prevented.

The recording pattern of the optical signal can be suitably selected based on the objective. Examples of the method of recording on the photosensitive layer are laser recording and recording by irradiation with ultraviolet radiation through a mask placed over the medium. Irradiation with light may be conducted from the magnetic layer side or from the support side, described further below. For example, when an ultraviolet absorbing material such as PET or PEN is employed as the nonmagnetic support and recording is conducted with ultraviolet radiation, or a light-blocking backcoat is provided, it is desirable to irradiate from the magnetic layer side.

[Nonmagnetic Layer]

When the above-described photosensitive layer is thick, a light passing through the photosensitive layer is absorbed and good optical characteristics cannot be achieved in deep layer portions of the photosensitive layer, as set forth above. Further, since the overall thickness of the coating layer, including the magnetic layer, becomes thinner when just the thickness of the photosensitive layer is reduced, forming properties by calendering deteriorate and the surface roughness of the magnetic layer increases. As a result, the spacing loss increases, the S/N of the magnetic recording signal drops, and surface reflectance decreases, resulting in a drop in the optical signal S/N. A lubricant can be added to the magnetic layer to achieve good running durability. However, as the thickness of the coating layer comprising the magnetic layer decreases, the surface roughness of the magnetic layer increases and a large quantity of lubricant must be added to the magnetic layer. As a result, the plasticity of the magnetic layer increases and durability decreases. Further, when a large quantity of lubricant is employed, the organic dye above-mentioned chemically reacts with the lubricant and there is a fear of a drop in the optical signal S/N.

Accordingly, in the magnetic recording medium of the second mode of the present invention, a nonmagnetic layer is provided between the photosensitive layer mentioned above and the nonmagnetic support, described further below. The nonmagnetic layer is provided between the nonmagnetic support and the photosensitive layer chiefly to reduce the thickness of the photosensitive layer and smoothen the magnetic layer surface. The nonmagnetic layer comprises a nonmagnetic pigment and a binder.

Any of the compounds given as examples for the photosensitive layer may be employed as the nonmagnetic pigment comprised in the nonmagnetic layer, either singly or in combinations of two or more. A nonmagnetic pigment identical to or different from that employed in the photosensitive layer may be employed. Preferred nonmagnetic pigments are, for example, electrically conductive SnO₂, ITO, and ZnO. The mean particle size of the nonmagnetic pigments desirably ranges from 3 to 300 nm, preferably from 5 to 200 nm, and more preferably from 5 to 100 nm.

The same binders given as examples for use in the photosensitive layer and magnetic layer may be employed in the nonmagnetic layer. The binder employed in the nonmagnetic layer may be identical to or different from the binder employed in the photosensitive layer and/or magnetic layer. Further, to the extent that optical characteristics are not affected, additives (dispersants, lubricants, and the like) may be added to the nonmagnetic layer. The examples of additives given for the magnetic layer may be employed.

The thickness of the nonmagnetic layer preferably ranges from 0.3 to 5 μm, more preferably from 0.5 to 3 μm. It is preferable that the thickness of the nonmagnetic layer ranges from 0.3 to 5 μm because the influence of the surface state of the nonmagnetic support described below can be effectively prevented.

[Nonmagnetic Support]

The support employed in the magnetic recording medium of the present invention is desirably nonmagnetic and flexible. Examples of such nonmagnetic supports are: polyesters such as polyethylene terephthalate and polyethylene naphthalate, polyolefins, cellulose triacetate, polycarbonates, polyamides, polyimides, polyamidoimides, polysulfones, polyaramides, aromatic polyamides, and polybenzooxazoles. Of these, the use of high-strength supports such as polyethylene naphthalate and polyamide is preferred. To change the surface roughness of the magnetic layer and support, a laminated support such as those described in Japanese Unexamined Patent Publication (KOKAI) Heisei No. 3-224127 may be employed as required. These supports may be subjected beforehand to corona discharge treatment, plasma treatment, adhesion-enhancing treatment, heat treatment, dust removal, or the like. Aluminum and glass substrates may be employed as the support in the present invention.

To achieve the objects of the present invention, the center surface average surface roughness of the nonmagnetic support as measured by the Mirau method with a TOPO-3D made by WYKO is equal to or less than 8.0 nm, preferably equal to or less than 4.0 nm, and more preferably equal to or less than 2.0 nm. Not only does such a support desirably have a low center surface average surface roughness, but there are also desirably no large protrusions equal to or higher than 0.5 μm. The surface roughness shape may be freely controlled through the size and quantity of filler added to the support as needed. Examples of such fillers are oxides and carbonates of elements such as Ca, Si, and Ti, and organic micropowders such as acrylic-based one.

The nonmagnetic support desirably has a maximum height SR_{MAX} equal to or less than 1 μm, a ten-point average roughness SR_{Z} equal to or less than 0.5 μm, a center surface peak height SR_{P} equal to or less than 0.5 μm, a center surface valley depth SR_{V} equal to or less than 0.5 μm, a center-surface surface area SSᵣ equal to or higher than 10 percent and equal to or less than 90 percent, and an average wavelength Sλₐ of 5 to 300 μm. To achieve desired electromagnetic characteristics and durability, the surface protrusion distribution of the nonmagnetic support can be freely controlled with fillers. It is possible to control within a range from 0 to 2,000 protrusions of 0.01 to 1 μm in size per 0.1 mm².

The F-5 value of the nonmagnetic support employed in the present invention desirably ranges from 0.049 to 0.49 GPa (5 to 50 kg/mm²). The thermal shrinkage rate of the nonmagnetic support after 30 min at 100° C. is preferably equal to or less than 3 percent, more preferably equal to or less than 1.5 percent. The thermal shrinkage rate after 30 min at 80° C. is preferably equal to or less than 1 percent, more preferably equal to or less than 0.5 percent. The breaking strength ranges from 0.049 to 0.98 GPa (5 to 100 kg/mm²). The modulus of elasticity preferably ranges from 0.98 to 19.6 GPa (100 to 2,000 kg/mm²). The thermal expansion coefficient ranges from 10⁻⁴ to 10⁻⁸/° C., preferably from 10⁻⁵ to 10⁻⁶/° C. The moisture expansion coefficient is equal to or less than 10⁻⁴/RH percent, preferably equal to or less than 10⁻⁵/RH percent. These thermal characteristics, dimensional characteristics, and mechanical strength characteristics are desirably nearly equal, with a difference equal to less than 10 percent, in all in-plane directions.

The thickness of the nonmagnetic support of the present invention ranges from 2 to 100 μm, preferably from 2 to 80 μm. In the case of a computer tape, the thickness of the nonmagnetic support ranges from 3.0 to 10 μm, preferably 3.0 to 7 μm. In the case of a flexible disc, the thickness of the nonmagnetic support ranges from 25 to 90 μm, preferably from 30 to 75 μm.

[Backcoat Layer, Undercoating Layer]

In the case of a tape magnetic recording medium, a backcoat layer may be provided on the reverse surface of the nonmagnetic support from the surface on which the magnetic layer is provided. The backcoat layer is useful for stabilizing running of the tape magnetic recording medium. The backcoat layer is normally about 0.1 to 1 am in thickness and preferably electrically conductive. Carbon black and binder may be incorporated into the backcoat layer. The same carbon black and binder as described above for the magnetic layer may be employed.

A metal oxide with a Mohs' hardness of 5 to 9, such as α-alumina or α-iron oxide, having an average particle size of 100 to 210 μm is desirably incorporated into the backcoat layer to reduce the fluctuation in the dynamic friction coefficient when the backcoat layer repeatedly slides against the tape guide of the recording and reproducing device or the tape guide of the cassette in which it is housed, and to achieve a backcoat layer of good durability. The metal oxide having a Mohs' hardness of 5 to 9 is desirably employed in a range of 3 to 20 mass parts per 100 mass parts of carbon black.

When the optical transmittance in the photosensitive layer is to be detected through the backcoat layer, the backcoat layer must be a transparent layer. Accordingly, in that case, the quantity of carbon black added is desirably adjusted to conform to the optical transmittance. When detecting reflectance, a reflective layer such as a metal vapor deposited film may be provided between the nonmagnetic support and the photosensitive layer.

To increase adhesion between the nonmagnetic support and the photosensitive layer, an undercoating layer may be further provided. The thickness of the undercoating layer preferably ranges from 0.01 to 0.5 μm, more preferably from 0.02 to 0.5 μm.

Although the magnetic recording medium of the present invention is usually a two-sided magnetic layer disk medium comprising a photosensitive layer and a magnetic layer sequentially provided on both surfaces of a nonmagnetic support, the photosensitive layer and magnetic layer may be provided on just one surface.

[Manufacturing Method]

The process of manufacturing a magnetic layer coating material and a photosensitive layer coating material of the magnetic recording medium of the present invention comprises at least a kneading step, a dispersing step, and a mixing step to be carried out, if necessary, before or after the kneading and dispersing steps. Each of the individual steps may be divided into two or more stages. All of the starting materials employed in the present invention, including the magnetic material, nonmagnetic pigments, organic dyes, binders, abrasives, antistatic agents, lubricants, solvents and the like, may be added at the beginning or during any of the steps. Moreover, the individual materials may be divided and added during two or more steps; for example, polyurethane may be divided and added in the kneading step, the dispersing step, and the mixing step for viscosity adjustment after dispersion. Conventionally known manufacturing techniques may be utilized for some of the steps in order to achieve the object of the present invention.

In the kneading step, it is preferable to use a kneader having a strong kneading force, such as an open kneader, a continuous kneader, a pressure kneader and an extruder. When employing a kneader, the ferromagnetic powder and all or part of the binder (preferably equal to or higher than 30 percent of the entire quantity of binder) are kneaded in the range of 15 to 500 parts per 100 parts of magnetic material. Details of the kneading treatment are described in Japanese Unexamined Patent Publication (KOKAI) Heisei No. 1-106338 and Japanese Unexamined Patent Publication (KOKAI) Heisei No. 1-79274. Glass beads can be used for dispersing a nonmagnetic layer coating liquid, a photosensitive layer coating liquid and a magnetic layer coating liquid. Preferred are zirconia beads, titania beads and steel beads with high specific gravity. These dispersing media are used optimizing a particle diameter and filling rate. Conventionally known dispersing device can be used.

The followings are examples of devices and methods for coating the information recording medium having a structure in which a nonmagnetic layer, a photosensitive layer and a magnetic layer are multilayered in the present invention.

1. The photosensitive layer (lower layer) for the first embodiment, the nonmagnetic layer (lower layer) for the second embodiment is first applied with a coating device commonly employed to apply magnetic liquid such as a gravure coating, roll coating, blade coating, or extrusion coating device, and the magnetic layer (upper layer) for the first embodiment, the photosensitive layer (middle layer) for the second embodiment is applied while the photosensitive layer (first embodiment) or the nonmagnetic layer (second embodiment) is still wet by means of a support pressure extrusion coating device such as is disclosed in Japanese Examined Patent Publication (KOKOKU) Heisei No. 1-46186 and Japanese Unexamined Patent Publication (KOKAI) Showa No. 60-238179 and Japanese Unexamined Patent Publication (KOKAI) Heisei No. 2-265672.

2. The upper and lower layers for the first embodiment, the lower and middle layers, the middle and upper layers or the upper, middle and lower layers for the second embodiment are applied nearly simultaneously by a single coating head having two built-in slits for passing coating liquid, such as is disclosed in Japanese Unexamined Patent Publication (KOKAI) Showa No. 63-88080, Japanese Unexamined Patent Publication (KOKAI) Heisei Nos. 2-17971, and 2-265672.

3. The upper and lower layers for the first embodiment, the lower and middle layers, the middle and upper layers or the upper, middle and lower layers for the second embodiment are applied nearly simultaneously using an extrusion coating apparatus with a backup roller as disclosed in Japanese Unexamined Patent Publication (KOKAI) Heisei No. 2-174965.

To prevent a drop in the electromagnetic characteristics of the magnetic recording medium due to aggregation of magnetic particles, shear is desirably imparted to the coating liquid within the coating head by a method such as is disclosed in Japanese Unexamined Patent Publication (KOKAI) Showa No. 62-95174 and Japanese Unexamined Patent Publication (KOKAI) Heisei No. 1-236968. Further, the viscosity of the coating liquid must satisfy the numerical ranges disclosed in Japanese Unexamined Patent Publication (KOKAI) Heisei No. 3-8471. To achieve the configuration of the present invention, in the first mode, a photosensitive layer (lower layer) can first be applied and dried, after which a magnetic layer (upper layer) can be applied thereover, and in the second mode, a nonmagnetic layer (lower layer) can first be coated and dried, after which a photosensitive layer (middle layer) and magnetic layer (upper layer) can be applied thereover using sequentially multilayer coating without losing the effect of the present invention. However, the use of the above-described simultaneous multilayer coating is desirable to improve qualities such as dropout.

In disks, it is sometimes possible to achieve adequately isotropic orientation without conducting orientation with an orienting device. However, the use of a known random orientation device in which cobalt magnets are reciprocally positioned at an angle and an alternating current is applied with a solenoid is preferred. Generally, isotropic orientation preferably refers to, in the case of ferromagnetic micropowder, in-plane two-dimensional randomness, but a vertical component can also be imparted and three-dimensional randomness achieved. In the case of hexagonal ferrite, it is generally easy to achieve in-plane and vertical three-dimensional randomness, but in-plane two-dimensional randomness is also possible. Further, known methods such as two-pole opposed magnets can be employed to impart vertical orientation, thereby imparting isotropic magnetic characteristics in a circumferential direction. In particular, during high-density recording, vertical orientation is desirable. Further, circumferential orientation may also be imparted by spin coating.

In magnetic tapes, cobalt magnets and solenoids are employed to impart orientation in the longitudinal direction. The temperature and flow rate of the drying air, and coating rate are desirably controlled to control the drying position of the coating. The coating rate preferably ranges from 20 to 1,000 m/min, and the temperature of the drying air is preferably equal to or higher than 60° C. It is also possible to conduct suitable predrying prior to entering the magnet zone.

Processing may be conducted with calender rolls in the form of heat-resistant plastic rolls such as epoxy, polyimide, polyamide, and polyimidoamide, or metal rolls. When forming two-surface magnetic layers, treatment with metal rolls is particularly desirable. The processing temperature is preferably equal to or higher than 50° C., more preferably equal to or higher than 100° C. The linear pressure is desirably equal to or higher than 200 kg/cm, more preferably equal to or higher than 300 kg/cm.

[Characteristics of the Magnetic Recording Medium]

The coefficient of friction of the magnetic recording medium of the present invention relative to the head is equal to or less than 0.5, preferably equal to or less than 0.3, at a temperature of −10° C. to 40° C. and a humidity of 0 percent to 95 percent. The surface specific resistivity of the magnetic surface is desirably 10⁴ to 10¹² Ω/sq and the charge potential preferably ranges from −500 V to +500 V. The modulus of elasticity at 0.5 percent elongation of the magnetic layer is desirably 0.98 to 19.6 GPa (100 to 2,000 kg/mm²) in all in-plane directions. The breaking strength is desirably 0.098 to 0.686 GPa (10 to 70 kg/mm²). The modulus of elasticity of the magnetic recording medium is desirably 0.98 to 14.7 GPa (100 to 1,500 kg/mm²) in all in-plane directions. The residual elongation is desirably equal to or less than 0.5 percent. The thermal shrinkage rate at temperatures below 100° C. is desirably equal to or less than 1 percent, preferably equal to or less than 0.5 percent, and more preferably equal to or less than 0.1 percent.

It will be readily understood that the physical characteristics of the nonmagnetic layer, the photosensitive layer and the magnetic layer can be changed based on the objective in the magnetic recording medium of the present invention. For example, the magnetic layer can be imparted with a high modulus of elasticity to improve running durability while at the same time imparting to the photosensitive layer a lower modulus of elasticity than that of the magnetic layer to improve head contact with the magnetic recording medium.

[Embodiment]

Specific embodiments of the present invention are described below; however, the present invention should not be limited thereto. Unless specifically stated otherwise, “parts” refers to “mass parts” in the embodiments.

[First Mode]

1. Embodiment of computer tape

| <Manufacturing of coating material> | | |
|---|---|---|
| Coating material for magnetic layer | | |
| Hexagonal barium ferrite magnetic powder | 100 | parts |
| Mean plate diameter: 30 nm | | |
| Mean plate thickness: 10 nm | | |
| Mean particle volume: 5800 nm³ | | |
| Present ratio of particles with a plate diameter of 10 nm | | |
| or less: 6 percent | | |
| Coercive force Hc: 183 kA/m | | |
| Saturation magnetization σ s: 50 Am²/kg | | |
| Specific surface area by BET method S_{BET}: 65 m²/g | | |
| Vinyl chloride copolymer | 10 | parts |
| MR110 (manufactured by Nippon Zeon Co., Ltd.) | | |
| Polyurethane resin | 5 | parts |
| UR8200 (manufactured by Toyobo Co., Ltd.) | | |
| α-alumina | 5 | parts |
| HIT55 (manufactured by Sumitomo Chemical Co., Ltd.) | | |
| Particle size: 0.2 μm | | |
| Carbon black | 1 | part |
| #55 (manufactured by Asahi Carbon Co., Ltd.) | | |
| Mean primary particle diameter: 0.075 μm | | |
| Specific surface area by BET method S_{BET}: 35 m²/g | | |
| DBP oil absorption capacity: 81 ml/100 g | | |
| pH 7.7 | | |
| Volatile content: 1.0 percent | | |
| Butyl stearate | 1.5 | parts |
| Stearic acid | 0.5 | parts |
| Methyl ethyl ketone | 150 | parts |
| Cyclohexanone | 150 | parts |
| Coating material for photosensitive layer | | |
| Nonmagnetic pigment TiO₂ (Rutil type) | 100 | parts |
| Mean major axis length: 0.035 μm | | |
| Specific surface area by BET method S_{BET}: 40 m²/g | | |
| pH: 7 | | |
| Surface treatment agent: Al₂O₃ | | |
| Cyanine based dye | 30 | parts |
| Vinyl chloride copolymer | 12 | parts |
| MR110 (manufactured by Nippon Zeon Co., Ltd.) | | |
| Polyurethane resin | 5 | parts |
| UR8200 (manufactured by Toyobo Co., Ltd.) | | |
| Butyl stearate | 1 | part |
| Stearic acid | 3 | parts |
| Methyl ethyl ketone/cyclohexanone (solvent mixed at 8/2) | 250 | parts |
| Coating material for backcoat layer | | |
| Carbon black | 100 | parts |
| Mean particle size: 17 mμ (manufactured by Cabot | | |
| Corporation) | | |
| Calcium Carbonate | 80 | parts |
| Mean particle size: 40 mμ (Manufactured by Shiraishi | | |
| Kogyo Co., Ltd.) | | |
| α-aluminan (hard inorganic powder) | 5 | parts |
| Mean particle size: 200 mμ (manufactured by Sumitomo | | |
| Chemical Co., Ltd.) | | |
| Nitrocellulose resin | 80 | parts |
| Polyurethane resin | 20 | parts |
| Polyisocianate | 5 | parts |

<Manufacturing Method>

With the above-mentioned coating material, each component was kneaded in a kneader and dispersed for four hours in a sandmill. To the dispersion obtained, added were 1.5 parts of polyisocyanate for the photosensitive layer coating liquid and 3 parts for the magnetic layer coating liquid, and 40 parts of cyclohexanone were added to each. The coating liquids were then passed through filters having a mean pore diameter of 1 μm to prepare a photosensitive layer-forming coating liquid and a magnetic layer-forming coating liquid. Simultaneous multilayer coating was conducted by applying the photosensitive layer-forming coating liquid in a manner yielding a dry thickness of 1.2 μm on a PEN support 6 μm in thickness and having a center surface average surface roughness of 2 nm, and applying the magnetic layer coating liquid immediately thereafter in a manner yielding a magnetic layer 0.1 μm in thickness. While the two layers were still wet, orientation was imparted with a cobalt magnet having a magnetic force of 600 mT (6,000 G) and a solenoid having a magnetic force of 600 mT (6,000 G). After drying, a seven-stage calender comprised of metal rolls was used for processing at 85° C. at a speed of 200 m/min, and a backcoat layer coating liquid was applied to a thickness of 0.5 μm. It was then slit into a one-half inch width, and fixed in a device having a device passing and winding the slit product so as to contact a nonwoven fabric and a razor blade with a magnetic surface. The magnetic layer surface was cleaned with a tape-cleaning device to obtain a tape sample.

The various properties of the computer tape were evaluated by the following measurement methods.

An LTO-Ultrium drive was modified for recording and reproducing both a magnetic signal and an optical signal.

(1) Recording and Reproduction of the Optical Signal

To achieve high recording density, an optical signal wavelength of 650 nm was employed and discolored bits were formed at intervals of 10 μm at a recording power of 8 mW at a linear velocity of 2 m/s with a semiconductor laser having a beam diameter of 1 μm. A semiconductor laser of identical wavelength was then directed thereupon and the reflected beam was detected by an optical detector. The ratio of the reflected light intensity of recorded portions to that of unrecorded portions was taken as the S/N ratio.

(2) Magnetic Signal C/N Ratio and Overwrite Deletion Rate

Measurements were conducted with an LTO-Ultrium drive equipped with a recording MIG head having a 10 μm recording track width and an MR head having a 5 μm reproduction track width. A single frequency signal was recorded at a recording wavelength of 0.25 μm at a head-media relative velocity of 10 m/min on a track on which the above-described optical signal had been recorded. A reproduced magnetic signal was frequency analyzed with a spectrum analyzer made by Shibasoku, and the ratio of the output voltage of the oned single frequency signal to the integral value of the noise of the entire band was taken as the S/N ratio. During reproduction, a bias current was applied to the MR head to maximize reproduction output. The overwrite deletion rate was measured by first recording a signal at a recording wavelength of 1 μm as a previous signal and measuring the survival rate of the recording wavelength signal when overwritten with a signal 0.25 μm in wavelength.

Tables 1 and 2 give these measurement results.

TABLE 1

| | | Emb. | Emb. | Emb. | Emb. | Emb. | Emb. | Emb. |
|---|---|---|---|---|---|---|---|---|
| Components | | 1 | 2 | 3 | 4 | 5 | 6 | 7 |
| Magnetic | Magnetic | BaFe | BaFe | BaFe | BaFe | BaFe | BaFe | BaFe |
| layer | material | | | | | | | |
| | Mean particle | 30 | 30 | 20 | 40 | 30 | 30 | 30 |
| | diameter [nm] | | | | | | | |
| | Br · δ [T · μm] | 0.012 | 0.035 | 0.007 | 0.011 | 0.012 | 0.012 | 0.012 |
| | Optical | 55 | 36 | 67 | 53 | 55 | 55 | 55 |
| | transmittance | | | | | | | |
| | (650 nm) [%] | | | | | | | |
| | Magnetic layer | 0.1 | 0.27 | 0.04 | 0.1 | 0.1 | 0.1 | 0.1 |
| | thickness | | | | | | | |
| | δ [μM] | | | | | | | |
| Photo- | Nonmagnetic | TiO₂ | TiO₂ | TiO₂ | TiO₂ | TiO₂ | ZnO | SnO₂ |
| sensitive | pigment | | | | | | | |
| layer | Pigment particle | 35 | 35 | 35 | 60 | 10 | 40 | 30 |
| | diameter [nm] | | | | | | | |
| | Photosensitive | 1.2 | 2.3 | 0.8 | 1.2 | 1.2 | 1.2 | 1.2 |
| | layer thickness | | | | | | | |
| | [μm] | | | | | | | |
| | Organic dye | Cya- | Cya- | Cya- | Cya- | Phthalo- | Cya- | Cya- |
| | | nine | nine | nine | nine | cycnine | nine | nine |
| | | based | based | based | based | | based | based |
| Measure- | Magnetic signal | 26.2 | 25.4 | 26 | 24.7 | 26.3 | 25.6 | 25.1 |
| ment | S/N [dB] | | | | | | | |
| value | Magnetic signal | | | | | | | |
| | overwrite [dB] | −28 | −26 | −31 | −27 | −29 | −28 | −29 |
| | Optical signal | 25.4 | 24 | 26.1 | 25.2 | 25.2 | 25.9 | 24.5 |
| | S/N [dB] | | | | | | | |

TABLE 2

| | | Emb. | Emb. | Emb. | Comp. | Comp. | Comp. | Comp. |
|---|---|---|---|---|---|---|---|---|
| Components | | 8 | 9 | 10 | Ex. 1 | Ex. 2 | Ex. 3 | Ex. 4 |
| Magnetic | Magnetic | BaFe | Fe—Co | BaFe | Fe—Co | Fe—Co | BaFe | BaFe |
| layer | material | | | | | | | |
| | Mean particle | 30 | 100 | 30 | 100 | 100 | 60 | 30 |
| | diameter [nm] | | | | | | | |
| | Br · δ [T · μm] | 0.012 | 0.015 | 0.012 | 0.06 | 0.06 | 0.055 | 0.003 |
| | Optical | 55 | 33 | 55 | 16 | 16 | 27 | 72 |
| | transmittance | | | | | | | |
| | (650 nm) [%] | | | | | | | |
| | Magnetic layer | 0.1 | 0.04 | 0.1 | 0.2 | 0.2 | 0.5 | 0.025 |
| | thickness | | | | | | | |
| | δ [μm] | Acicular | TiO₂ | SiO₂ | TiO₂ | TiO₂ | TiO₂ | TiO₂ |
| Photo- | Nonmagnetic | Fe₂O₃ | | | | | | |
| sensitive | pigment | 150 | 35 | 3 | 35 | 35 | 35 | 35 |
| layer | Pigment particle | | | | | | | |
| | diameter [nm] | | | | | | | |
| | Photosensitive | 1.2 | 2.3 | 1.2 | 1.2 | 1.2 | 1.2 | 1.2 |
| | layer thickness | | | | | | | |
| | [μm] | | | | | | | |
| | Organic dye | Cya- | Cya- | Cya- | — | Cya- | Cya- | Cya- |
| | | nine | nine | nine | | nine | nine | nine |
| | | based | based | based | | based | based | based |
| Measure- | Magnetic signal | 22.5 | 21.0 | 21.3 | 15.1 | 17.2 | 16 | 17.5 |
| ment | S/N [dB] | | | | | | | |
| value | Magnetic signal | −25 | −30 | −24 | −18 | −16 | −13 | −33 |
| | overwrite [dB] | | | | | | | |
| | Optical signal | 21 | 22 | 21.2 | — | 9 | 17 | 28.1 |
| | S/N [dB] | | | | | | | |

Comparative Example 1 was a magnetic tape having a nonmagnetic layer instead of a photosensitive layer made for use in an LTO-Ultrium. The magnetic servo pattern employed by the same system was recorded and reproduced as a reference for the embodiments.

The magnetic servo pattern was recorded at a position spaced 100 μm apart from a data recording track on a single surface or layer. Since the track width (5 μm) of the magnetic signal for data was narrower than that of the above-described LTO system (12 μm during reproduction), adequate S/N and overwrite deletion rate could not be obtained in the conventional servo method due to off-track.

In Embodiments 1 to 8 and Comparative Examples 3 and 4, barium ferrite was employed as the ferromagnetic material.

Embodiments 1 to 7 all exceeded the workable threshold of 20 dB, exhibiting good servo optical signal SIN. In Embodiments 1 to 7, optimization design of the magnetic layer for an MR head was conducted, resulting in good magnetic signal S/N and magnetic signal overwrite deletion rates.

In Embodiment 8, acicular Fe₂O₃ was employed as the nonmagnetic pigment in the photosensitive layer. Since there was optical absorption in the photosensitive layer at 650 nm, the optical signal S/N exceeded the workable threshold of 20 dB, but it was lower than in Embodiments 1 to 7. Thus, the off-track probability increased and the magnetic signal SIN exceeded the workable threshold of 20 dB, but was also lower than in Embodiments 1 to 7.

In Embodiment 10, SiO₂ particles 3 nm in diameter were employed in the photosensitive layer. Dispersion was difficult, the magnetic surface was rough, and there was scattered reflection by the photosensitive layer. Although the workable threshold of 20 dB was exceeded, the SIN was lower than in Embodiments 1 to 7.

In Comparative Example 3 and 4, the product of Br·δ exceeded the range of the present invention. In Comparative Example 3, Br·δ was greater than 0.05, resulting in both the optical signal S/N and the magnetic signal overwrite deletion rate falling below the workable threshold of 20 dB. Further, in Comparative Example 4, Br·δ was smaller than 0.005, resulting in the magnetic signal S/N falling below the workable threshold of 20 dB.

In Embodiment 9 and Comparative Example 2, ferromagnetic metal powder was employed as the ferromagnetic material.

In Embodiment 9, a magnetic layer of the same composition as in Comparative Example 2 was applied to a thickness of 0.04 μm on the photosensitive layer of Embodiment 2, resulting in a higher SIN than in Comparative Example 2. However, since black Fe-Co was employed as the magnetic material, it was necessary to employ a thinner magnetic layer to ensure optical transmittance of the magnetic layer. This resulted in a lower number of magnetic particles required for magnetic recording. Although the workable threshold of 20 dB was exceeded, the S/N was lower than those of the other embodiments.

In Comparative Example 2, a magnetic layer of the same composition as in Comparative Example 1 was applied on the photosensitive layer of Embodiment 1. Since the Br-6 was high and optical transmittance a was lower than 30 percent, the magnetic signal S/N was somewhat better, but did not reach the workable threshold.

2. Embodiments of Flexible Disks

The quantity of butyl stearate added to the magnetic layer coating material in the above-described embodiments of computer tapes was changed to 10 parts and the quantity of alumina to 10 parts, the quantity of butyl stearate added to the photosensitive layer coating liquid was changed to 10 parts, and each coating liquid was prepared.

These coating liquids were applied by the same method as employed for the computer tapes to both surfaces of a 60 μm PET base, subjected to a known method of random orientation, and dried. The same calendering was conducted as for the computer tapes, 3.5-inch disks were punched out, and flexible disks were obtained.

Recording and reproduction of a magnetic signal and optical signal were conducted with a modified spin stand made by GUZIK Co.

(1) Recording and Reproduction of the Optical Signal

Discolored bits were formed on the circumference at intervals of 10 μm at a recording power of 8 mW at 3,600 rpms with a semiconductor laser having a beam diameter of 1 μm. A semiconductor laser of identical wavelength was then directed thereupon and the transmitted light was detected with a photodetector. The ratio of the transmitted light intensity of recorded portions to that of the unrecorded portions was taken as the S/N.

(2) The Magnetic Signal S/N Ratio

A square wave 0.3 μm in wavelength was recorded with a recording head mounted on a ZIP-250 drive made by Iomega, and recorded and reproduced at 3,600 rpm with an A-MR head (track width 2 μm) for commercially available hard disk drives. The reproduced signal was frequency analyzed with a spectrum analyzer from Shibasoku, and the ratio of the output voltage of the single frequency signal to the integral value of total bandwidth noise was taken as the SIN. A bias current was applied to the MR head during reproduction to achieve the maximum reproduction output.

Table 3 gives the results of these measurements.

TABLE 3

| | | Emb. | Emb. | Emb. | Comp. | Comp. |
|---|---|---|---|---|---|---|
| Components | | 11 | 12 | 13 | Ex. 5 | Ex. 6 |
| Magnetic | Magnetic material | BaFe | BaFe | Fe—Co | Fe—Co | BaFe |
| layer | Mean particle | 30 | 30 | 120 | 120 | 30 |
| | diameter [nm] | | | | | |
| | Br · δ [T · μm] | 0.012 | 0.007 | 0.015 | 0.08 | 0.07 |
| | Optical | 57 | 69 | 36 | 8 | 23 |
| | transmittance | | | | | |
| | (650 nm) [%] | | | | | |
| | Magnetic layer | 0.1 | 0.05 | 0.04 | 0.3 | 0.4 |
| | thickness δ [μm] | | | | | |
| Photo- | Nonmagnetic | TiO₂ | TiO₂ | TiO₂ | TiO₂ | TiO₂ |
| sensitive | pigment | | | | | |
| layer | Pigment particle | 35 | 35 | 35 | 35 | 35 |
| | diameter [nm] | | | | | |
| | Photosensitive | 0.5 | 1.2 | 0.3 | 1.2 | 3.0 |
| | layer | | | | | |
| | thickness [μm] | | | | | |
| | Organic dye | Cyanine | Cyanine | Cyanine | None | Cyanine |
| | | based | based | based | | based |
| Measure- | Magnetic signal | 25.2 | 24.3 | 20.4 | 16.5 | 18.3 |
| ment | S/N [dB] | | | | | |
| value | Optical signal | 24.5 | 23.2 | 21 | — | 17.6 |
| | S/N [dB] | | | | | |

In the disks, the thickness of the photosensitive layer was made smaller than that used when detecting reflecting light to detect transmitted light. In Embodiments 11 and 12, good optical signal S/N and magnetic signal SIN were obtained. In Embodiment 13, the magnetic layer of Comparative Example 5 was coated to a thickness of 0.04 μm on the photosensitive layer of Embodiment 11. This embodiment had a lower magnetic signal S/N and optical signal SIN than both Embodiments 11 and 12. However, it exhibited a value exceeding the workable threshold.

Comparative Example 5 was a disk made to conform to the ZIP-250. Servo writing was also conducted with a magnetic servo (sector servo) designed for the ZIP-250. However, the reproduction track width was narrower than that of the ZIP-250 and an adequate S/N was not achieved.

In Comparative Example 6, both the magnetic layer and the photosensitive layer were outside the ranges of the present invention and adequate S/N could not be obtained.

| Coating material for nonmagnetic layer | | |
|---|---|---|
| Nonmagnetic pigment TiO₂ (Rutil type) | 100 | parts |
| Mean major axis length: 0.035 μm | | |
| Specific surface area by BET method S_{BET}: 40 m²/g | | |
| pH: 7 | | |
| Surface treatment agent: Al₂O₃ | | |
| Vinyl chloride copolymer | 12 | parts |
| MR110 (manufactured by Nippon Zeon Co., Ltd.) | | |
| Polyurethane resin | 5 | parts |
| UR8200 (manufactured by Toyobo Co., Ltd.) | | |
| Butyl stearate | 1 | part |
| Stearic acid | 3 | parts |
| Methyl ethyl ketone/cyclohexanone (solvent mixed at 8/2) | 250 | parts |

<Manufacturing Method>

The same magnetic layer coating material, photosensitive layer coating material, and backcoat layer coating material were employed as in Embodiment 1. With the above-mentioned coating materials, each component was kneaded in a kneader and dispersed for four hours in a sandmill. Polyisocyanate was added to the dispersions obtained: 1.5 parts each to the nonmagnetic layer and photosensitive layer coating liquids and 3 parts to the magnetic layer coating liquid; 40 parts of cyclohexanone were then added to each. The coating liquids were then passed through a filter having an average pore diameter of 1 μm to prepare the nonmagnetic layer coating liquid, photosensitive layer-forming coating liquid, and magnetic layer-forming coating liquid. Each of the coating liquids obtained was simultaneously multilayer coated on a PEN support having a center surface average surface roughness of 2 nm and a thickness of 6 μm to a dry thickness of 1 μm for the nonmagnetic layer, 0.3 μm for the photosensitive layer, and 0.1 μm for the magnetic layer. While each layer was still wet, the layers were oriented with a cobalt magnet having a magnetic force of 600 mT (6,000 G) and a solenoid having a magnetic force of 600 mT (6,000 G). After drying, a seven-stage calender comprised of only metal rolls was used for processing at 85° C. at a speed of 200 m/min, and a backcoat layer coating liquid was applied to a thickness of 0.5% m. It was then slit into a one-half inch width, and fixed in a device having a device passing and winding the slit product so as to contact a nonwoven fabric and a razor blade with a magnetic surface. The magnetic layer surface was cleaned with a tape-cleaning device to obtain a tape sample.

The various properties of the computer tape were evaluated by the same measuring methods employed in the first mode.

The measurement results are given in Tables 4 and 5.

TABLE 4

| | | Emb. | Emb. | Emb. | Emb. | Emb. | Emb. | Emb. |
|---|---|---|---|---|---|---|---|---|
| Components | | 14 | 15 | 16 | 17 | 18 | 19 | 20 |
| Magnetic | Magnetic | BaFe | BaFe | BaFe | BaFe | BaFe | BaFe | BaFe |
| layer | material | | | | | | | |
| | Mean | 30 | 30 | 20 | 40 | 30 | 30 | 30 |
| | particle | | | | | | | |
| | diameter | | | | | | | |
| | [nm] | | | | | | | |
| | Br · δ [T · μm] | 0.012 | 0.035 | 0.007 | 0.011 | 0.012 | 0.012 | 0.012 |
| | Optical | 55 | 36 | 67 | 53 | 55 | 55 | 55 |
| | transmittance | | | | | | | |
| | α (650 nm) | | | | | | | |
| | [%] | | | | | | | |
| | Magnetic layer | 0.1 | 0.27 | 0.04 | 0.1 | 0.1 | 0.1 | 0.1 |
| | thickness δ | | | | | | | |
| | [μm] | | | | | | | |
| Photo- | Nonmagnetic | TiO₂ | TiO₂ | TiO₂ | TiO₂ | TiO₂ | ZnO | SnO₂ |
| sensitive | pigment | | | | | | | |
| layer | Pigment | 35 | 35 | 35 | 60 | 10 | 40 | 30 |
| | particle | | | | | | | |
| | diameter [nm] | | | | | | | |
| | Photosensitive | 0.3 | 0.8 | 0.15 | 0.3 | 0.5 | 0.5 | 0.5 |
| | layer | | | | | | | |
| | thickness | | | | | | | |
| | [μm] | | | | | | | |
| | Organic dye | Cya- | Cya- | Cya- | Cya- | Phthalo- | Cya- | Cya- |
| | | nine | nine | nine | nine | cycnine | nine | nine |
| | | based | based | based | based | | based | based |
| Non- | Nonmagnetic | TiO₂ | TiO₂ | TiO₂ | Acicular | TiO₂ | TiO₂ | TiO₂ |
| magnetic | pigment | | | | Fe₂O₃ | | | |
| layer | Nonmagnetic | 1.0 | 1.0 | 1.0 | 0.6 | 1.0 | 1.0 | 1.0 |
| | layer | | | | | | | |
| | thickness | | | | | | | |
| | [μm] | | | | | | | |
| Measure- | Magnetic | 29.6 | 28.5 | 28.9 | 27.9 | 28.5 | 29.8 | 28.5 |
| ment | signal S/N [dB] | | | | | | | |
| value | Magnetic | −28 | −26 | −31 | −27 | −29 | −28 | −29 |
| | signal | | | | | | | |
| | overwrite [dB] | | | | | | | |
| | Optical signal | 28.2 | 27.5 | 28.2 | 27.6 | 27.9 | 29.1 | 28.7 |
| | S/N [dB] | | | | | | | |

TABLE 5

| | | Emb. | Emb. | Comp. | Comp. | Comp. | Comp. |
|---|---|---|---|---|---|---|---|
| Component | | 21 | 22 | Ex. 7 | Ex. 8 | Ex. 9 | Ex. 10 |
| Magnetic | Magnetic | BaFe | BaFe | Fe—Co | BaFe | BaFe | BaFe |
| layer | material | | | | | | |
| | Mean particle | 30 | 30 | 100 | 30 | 30 | 60 |
| | diameter [nm] | | | | | | |
| | Br · δ [T · μm] | 0.012 | 0.012 | 0.06 | 0.012 | 0.012 | 0.055 |
| | Optical | 55 | 55 | 16 | 55 | 55 | 27 |
| | transmittance | | | | | | |
| | (650 nm) [%] | | | | | | |
| | Magnetic | 0.1 | 0.1 | 0.2 | 0.1 | 0.1 | 0.5 |
| | layer | | | | | | |
| | thickness δ | | | | | | |
| | [μm] | | | | | | |
| Photo- | Nonmagnetic | TiO₂ | SiO₂ | TiO₂ | — | TiO₂ | TiO₂ |
| sensitive | pigment | | | | | | |
| layer | Pigment | 35 | 3 | 35 | — | 35 | 35 |
| | particle | | | | | | |
| | diameter [nm] | | | | | | |
| | Photosensitive | 1.2 | 0.3 | 1.2 | — | 0.3 | 1.2 |
| | layer thickness | | | | | | |
| | [μm] | | | | | | |
| | Organic dye | Cya- | Cya- | — | — | Cya- | Cya- |
| | | nine | nine | | | nine | nine |
| | | based | based | | | based | based |
| Non- | Nonmagnetic | TiO₂ | TiO₂ | — | — | — | TiO₂ |
| magnetic | pigment | | | | | | |
| layer | Nonmagnetic | 1.0 | 1.0 | — | — | — | 1.0 |
| | layer thickness | | | | | | |
| | [μm] | | | | | | |
| Measure- | Magnetic | 26 | 24.5 | 15.1 | 17.2 | 19 | 18 |
| ment | signal S/N [dB] | | | | | | |
| value | Magnetic | −28 | −24 | −18 | −21 | −22 | −13 |
| | signal | | | | | | |
| | overwrite [dB] | | | | | | |
| | Optical signal | 25.4 | 24.2 | — | — | 23 | 17 |
| | S/N [dB] | | | | | | |

Comparative Example 7 was a magnetic tape having a nonmagnetic layer instead of a photosensitive layer made for use in an LTO-Ultrium. The magnetic servo pattern employed by the same system was recorded and reproduced as a reference for the embodiments.

The magnetic servo pattern was recorded at a position spaced 100 μm apart from a data recording track on a single surface or layer. Since the track width (5 μm) of the magnetic signal for data was narrower than that of the above-described LTO system (12 μm during reproduction), adequate S/N and overwrite deletion rate could not be obtained in the conventional servo method due to off-track.

Embodiments 14 to 20 all exceeded the workable threshold of 20 dB and had good servo optical signal SIN. In Embodiments 14 to 20, the magnetic layer was optimally designed for an MR head, resulting in good magnetic signal S/N and magnetic signal overwrite deletion rates.

In Embodiment 21, the photosensitive layer had a thickness of 1.2 μm. Thus, the optical signal S/N exceeded the workable threshold of 20 dB, but it was lower than those in Embodiments 14 to 20. It was understood that as the thickness of the photosensitive layer increases, the magnetic signal S/N and the optical signal S/N both drops.

In Embodiment 22, SiO₂ particles 3 nm in diameter were employed in the photosensitive layer. Dispersion was difficult, the magnetic surface was rough, and there was scattered reflection by the photosensitive layer. Although the workable threshold of 20 dB was exceeded, the S/N was lower than those of Embodiments 14 to 20.

By contrast, Comparative Example 8 was the magnetic recording medium of Embodiment 14 without both a photosensitive layer and a nonmagnetic layer, and thus had a magnetic signal S/N falling below the workable threshold of 20 dB.

Comparative Example 9 was the magnetic recording medium of Embodiment 14 without only the nonmagnetic layer. The coated layers had little overall thickness, calendering forming properties deteriorated, and the magnetic signal SIN fell below the workable threshold of 20 dB.

Comparative Example 10 was a magnetic recording medium with an optical transmittance α in the magnetic layer of less than 30 percent. The optical signal SIN fell below the workable threshold of 20 dB. Further, since Br·δ was greater than 0.05, the magnetic signal SIN dropped and overwriting deletion decreased.

2. Embodiments of Flexible Disks

The quantity of alumina added to the magnetic layer coating material in the above-described embodiments of computer tapes was changed to 10 parts and the quantity of butyl stearate to 10 parts, the quantity of butyl stearate added to the photosensitive layer coating material was changed to 10 parts, and each coating liquid was prepared.

These coating liquids were applied by the same method as employed for the computer tapes to both surfaces of a 60 μm PET base, subjected to known random orientation, and dried. The same calendering was conducted as for the computer tapes, 3.5-inch disks were punched out, and flexible disks were obtained.

Magnetic signals and optical signals were recorded and reproduced and the SIN of the magnetic signals was measured in the same manner as in the above-described first mode. The results of these measurements are given in Table 6.

TABLE 6

| | | Emb. | Emb. | Emb. | Comp. | Comp. |
|---|---|---|---|---|---|---|
| Components | | 23 | 24 | 25 | Ex. 11 | Ex. 12 |
| Magnetic | Magnetic | BaFe | BaFe | Fe—Co | Fe—Co | BaFe |
| layer | material | | | | | |
| | Mean particle | 30 | 30 | 120 | 120 | 30 |
| | diameter [nm] | | | | | |
| | Br · δ [T · μm] | 0.012 | 0.007 | 0.015 | 0.08 | 0.012 |
| | Optical | 57 | 69 | 36 | 8 | 57 |
| | transmittance | | | | | |
| | (650 nm) [%] | | | | | |
| | Magnetic | 0.1 | 0.05 | 0.04 | 0.3 | 0.1 |
| | layer thickness | | | | | |
| | δ [μm] | | | | | |
| Photo- | Nonmagnetic | TiO₂ | TiO₂ | TiO₂ | — | TiO₂ |
| sensitive | pigment | | | | | |
| layer | Pigment | 35 | 35 | 35 | — | 35 |
| | particle | | | | | |
| | diameter [nm] | | | | | |
| | Photosensitive | 0.3 | 1.2 | 0.3 | — | 0.3 |
| | layer thickness | | | | | |
| | [μm] | | | | | |
| | Organic dye | Cya | Cya- | Cya- | — | Cya- |
| | | nine | nine | nine | | nine |
| | | based | based | based | | based |
| Non- | Nonmagnetic | TiO₂ | TiO₂ | TiO₂ | — | — |
| magnetic | pigment | | | | | |
| layer | Nonmagnetic | 1.0 | 1.0 | 1.0 | — | — |
| | layer thickness | | | | | |
| | [μm] | | | | | |
| Measure- | Magnetic | 28.7 | 24.1 | 24.2 | 16.5 | 20.6 |
| ment | signal | | | | | |
| value | S/N [dB] | | | | | |
| | Optical signal | 27.6 | 23.5 | 23.7 | — | 19.7 |
| | S/N [dB] | | | | | |

In the disks, the thickness of the photosensitive layer was made smaller than that used when detecting reflecting light to detect transmitted light. Embodiment 23 exhibited a good optical signal S/N and a good magnetic signal S/N. Embodiment 24 was identical to Embodiment 23 with the exception that the photosensitive layer was coated to a thickness of 1.2 μm. It was workable, but had a lower magnetic signal SIN and a lower optical signal SIN than in Embodiment 23.

Comparative Example 11 was a disk produced to conform to the ZIP-250. Servo writing was conducted with a magnetic servo (sector servo) for ZIP-250. However, the reproduction track width was narrower than that of the ZIP-250 and an inadequate S/N was achieved.

Comparative Example 12 did not have a nonmagnetic layer and did not achieve an adequate S/N.

On the magnetic recording medium of the present invention, recording capacity can be increased, while affording a servo precision and tracking property adequate for a narrow track. Further, the magnetic recording medium of the present invention can yield high S/N for both magnetic recording signals and optical recording signals.

The present disclosure relates to the subject matter contained in Japanese Patent Application No. 2001-166295 filed on Jun. 1, 2001 and Japanese Patent Application No. 2001-166297 filed on Jun. 1, 2001, which are expressly incorporated herein by reference in its entirety.

What is claimed is:

1. A magnetic recording medium comprising a magnetic layer comprising a ferromagnetic powder and a binder on a nonmagnetic support, wherein
a photosensitive layer comprising an organic dye and a nonmagnetic pigment is provided between said nonmagnetic support and said magnetic layer,
said magnetic layer has an optical transmittance α equal to or higher than 30 percent at an absorption peak wavelength of said organic dye, and
a product Br·δ of a residual magnetic flux density Br and a magnetic layer thickness δ ranges from 0.005 to 0.05 T·μm.

2. The magnetic recording medium of claim 1, wherein said ferromagnetic power is a hexagonal ferrite ferromagnetic powder with an average particle size of 10 to 50 nm

3. The magnetic recording medium of claim 1, wherein said magnetic layer has a thickness ranging from 0.03 to 0.3 μm.

4. The magnetic recording medium of claim 1, wherein said photosensitive layer has a thickness ranging from 0.2 to 2.5 μm.

5. The magnetic recording medium of claim 1, wherein said nonmagnetic pigment is a white pigment.

6. The magnetic recording medium of claim 1, wherein said nonmagnetic pigment has an average particle size of equal to or higher than 3 nm and equal to or less than ½ of the absorption peak wavelength of said organic dye.

7. A method of utilizing the magnetic recording medium of claim 1, wherein magnetic recording information recorded on the magnetic layer is reproduced with a magnetoresistive head.

8. A magnetic recording medium comprising a nonmagnetic layer comprising a nonmagnetic powder and a binder and a magnetic layer comprising a ferromagnetic powder and a binder in this order, wherein
a photosensitive layer comprising an organic dye and a nonmagnetic pigment is provided between said nonmagnetic layer and a magnetic layer, and
said magnetic layer has an optical transmittance equal to or higher than 30 percent at an absorption peak wavelength of said organic dye.

9. The magnetic recording medium of claim 8, wherein said magnetic recording medium exhibits a product Br·δ of the residual magnetic flux density Br of the magnetic layer multiplied by the magnetic layer thickness δ ranges from 0.005 to 0.05 T·μm.

10. The magnetic recording medium of claim 8, wherein said ferromagnetic powder is hexagonal ferrite ferromagnetic power with an average particle size of 10 to 50 nm.

11. The magnetic recording medium of claim 8, wherein said magnetic layer has a thickness ranging from 0.03 to 0.3 μm.

12. The magnetic recording medium of claim 8, wherein said photosensitive layer has a thickness ranging from 0.1 to 0.8 μm.

13. The magnetic recording medium of claim 8, wherein said nonmagnetic pigment has an average particle size of equal to or higher than 3 nm and equal to or less than ½ of the absorption peak wavelength of said organic dye.

14. A method of utilizing the magnetic recording medium of claim 8, wherein magnetic recording information recorded on the magnetic layer is reproduced with a magnetoresistive head.
